(19) United States
(12) Patent Application Publication
(10) Pub. No.: US 2007/0154218 A1
(43) Pub. Date: Jul. 5, 2007

(54) Optical discriminators and systems and methods

(75) Inventor: Rad Sommer, Sebastopol, CA (US)

Correspondence Address: BANNER & WITCOFF, LTD., 28 STATE STREET, 28th FLOOR, BOSTON, MA, 02109-9601, US

(73) Assignee: Bookham Technology, plc, Towcester (GB)

(21) Appl. No.: 11/501,977

(22) Filed: Aug. 9, 2006

Related U.S. Application Data
(60) Provisional application No. 60/755,614, filed on Dec. 30, 2005.

(51) Int. Cl. H04J 14/02

(52) U.S. Cl. 398/85

(57) ABSTRACT

An optical multi-filter discriminator suitable for treating optical signals from an optical signal source, e.g., a direct modulated laser (“DML”), comprises a first optical filter, a second optical filter optically coupled to the first optical filter, an input port operative to receive optical signals from an optical signal source and oriented to launch the optical signals directly or indirectly to the first optical filter, and an output port oriented to receive optical signals treated by the multiple optical filters and operative to pass the optical signals directly or indirectly to an optical waveguide “downstream” of the discriminator. The first filter is transmissive (i.e., at the angle of incidence received from the input port) of at least a first wavelength band having a first center wavelength and reflective (again, meaning in this instance at the angle of incidence received from the input port) of at least a second wavelength band different from the first wavelength band. The optical multi-filter discriminator defines an optical path for optical signals in the first wavelength band received by the input port. The optical path includes at least (i) transmission from the input port directly or indirectly to and through the first optical filter, and (ii) then, prior to the output port, from the first optical filter directly or indirectly to the second optical filter at an angle of incidence at which the second optical filter is reflective of the first wavelength band. The at least two filters of the optical multi-filter discriminator can be packaged together in a common housing along with some or all of the other components, if any, of the optical multi-filter discriminator, e.g., lenses, isolators, mounting components, etc. An optical communication system comprises a DML or other optical signal source optically coupled to one or more of the aforesaid optical multi-filter discriminators. A method of operating an optical communication system comprises actuating an optical signal source to generate optical signals to one or more of the aforesaid optical multi-filter discriminators to increase the extinction ratio, and by passing the signals through the multi-discriminator to a downstream optical fiber or other optical waveguide.

### CROSS-REFERENCED APPLICATION

This application claims the priority benefit of U.S. Provisional Application No. 60/755,614, filed Dec. 30, 2005 by Rad Sommer.

### FIELD OF THE INVENTION

The present invention is directed to systems, devices and method for treating or processing optical signals. Certain aspects are directed to systems, devices and methods for narrowing or otherwise controlling output of a directly modulated laser (“DML”). Certain aspects are directed to fiber optic systems incorporating such systems, devices and methods for narrowing or otherwise controlling optical signal output, especially a spectrally broadened output of a DML. Certain aspects are directed to systems, devices and methods comprising an optical discriminator to provide improved extinction ratio and chromatic dispersion compensation to the output of an optical signal source, such as a DML. Certain aspects are directed to systems, devices and methods operative to convert a partially frequency modulated signal into a substantially amplitude modulated signal and to compensate for signal dispersion in an associated waveguide, e.g., an optical transmission fiber of a fiber optic system, such as a telecommunication system.

### BACKGROUND

Optical signal systems use a variety of means to convert electrical signals encoding information or data into corresponding optical signals encoding the same information and suitable for transmission along an optical waveguide. Typically, light pulses are generated in a pattern corresponding to 1s and 0s or marks and nulls encoding the information to be carried through an optical fiber to a receiving end. The optical signals can be generated by modulating the emitted light output of one or more lasers. The light can be modulated with an external modulator, such as a Mach-Zehnder interferometer. Such external modulators are effective, though expensive, and insert loss into the system. Optical amplifiers to compensate for such loss add to the cost of the system. The light can be modulated by use of a directly modulated laser, such as a semiconductor distributed feedback (DFB) DML. Directly modulated transmitters can enable a compact system with good response to modulation. DMLs can generate high power optical output, requiring fewer or no optical amplifiers, depending on other aspects of the optical system. The output of a directly modulated transmitter, however, typically is chirped or broadened beyond the signals' desired wavelength band. Such output pulses can in some optical systems become distorted during propagation along an optical fiber. Optical discriminators can increase the extinction ratio of the signal, removing some component(s) of the signal in favor of other(s) and/or provide dispersion compensation to the signals. The extinction ratio is the ratio of the high or on optical power level (PH) to the low or off optical power level (PL), such as 1s and 0s generated by an optical signal source (Extinction Ratio (%)=(PH/PL)*100). A variety of optical discriminators are known.

The use of a laser source that produces a partially frequency modulated signal and an optical discriminator is discussed in UK Patent GB2107147A to Epworth. In Epworth the laser is initially biased to a current level above the lasing threshold. A partial amplitude modulation of the bias current is applied yielding a partial but significant modulation in the frequency of the laser output, synchronous with the power amplitude changes. This partially frequency modulated output may then be applied to an optical discriminator, such as a filter tuned to pass light only at the desired frequencies. In this manner, the partially frequency modulated signal can be converted into a substantially amplitude modulated signal.

There is a need for improved optical discriminators that can increase the extinction ratio of optical signals, especially, for example, signals generated by DMLs and the like. There is a need also for improved optical discriminators that can remove unwanted component(s) of optical signals to convert partially frequency modulated signals into substantially amplitude modulated signals, especially, for example, at high bit rates. There is a need also for improved optical discriminators that can provide dispersion compensation to optical signals. There is a need also for optical discriminators that are operative with low sensitivity to temperature changes. There is a need also for correspondingly improved optical signal systems.

It is an object of the present invention to provide systems, devices and method for treating or processing optical signals. It is a particular object of at least certain aspects of the invention to provide systems, devices and methods for narrowing or otherwise controlling optical signal output of a directly modulated laser. It is a particular object of at least certain aspects to provide systems, devices and methods comprising an optical discriminator to increase extinction ratio and provide chromatic dispersion compensation. It is a particular object of at least certain aspects to provide systems, devices and methods operative to convert a partially frequency modulated signal into a substantially amplitude modulated signal and to compensate for dispersion in an associated waveguide, e.g., an optical transmission fiber of a fiber optic system, such as a telecommunication system. It is a particular object of at least certain aspects to provide optical signal systems incorporating systems, devices and methods comprising improved optical discriminators that can operate with FM modulated light sources, e.g., at high bit rates and with low sensitivity to temperature changes. Additional objects of the invention or of certain aspects thereof will be apparent to those skilled in the art from the following disclosure of the invention and description of certain aspects and embodiments thereof.

### SUMMARY

Optical multi-filter discriminators are disclosed, along with their use in optical systems, for treating optical signals from an optical signal source, e.g., a direct modulated laser (“DML”). The multi-filter discriminators disclosed here have at least a first optical filter and a second optical filter and optionally have more than two filters, e.g., three filters or more. The first optical filter is transmissive of a wavelength band having a first center wavelength and reflective of a second, different wavelength band. The second optical filter is optically coupled to the first optical filter to receive the optical signal passed by the first filter. For such first wavelength band the optical path through the multi-filter discriminator includes at least transmission from the input port to the first optical filter, then through the first filter to the second optical filter, and then from the second optical filter to the output port, optionally passing again to the first filter from the second filter. At least one of the multiple filters of the discriminator passes the desired wavelength band of the optical signal at least once and the other optical filter reflects such desired wavelength band at least once; for the desired wavelength band the optical path through the multi-filter discriminator intersects (i.e., is passed by or is reflected by) multiple times at least one of the multiple filters of the discriminator. In certain exemplary embodiments the second optical filter is transmissive of the first wavelength band (e.g., a particular channel of a multiplexed optical signal system) and reflective of a second wavelength band, e.g., adjacent components of an optical signal output from a modulated laser. In such embodiments the optical path for optical signals in the first wavelength band further comprises transmission through the second optical filter directly or indirectly to the output port of the optical discriminator. In certain other exemplary embodiments the second optical filter is transmissive of the second wavelength band and reflective of the first wavelength band, and the optical path for optical signals in the first wavelength band further comprises reflection from the second optical filter, such as back to the first optical filter and then again through the first optical filter to the output port. As used here and in the appended claims, treating or processing optical signals by the optical multi-filter discriminators disclosed here means passing optical signals through the multi-filter discriminator or, with respect to an individual filter of the discriminator, passing or reflecting a wavelength band or other component(s) of an optical input. In certain exemplary embodiments such processing of optical signals comprises passing the signals to the input port of the optical multi-filter discriminator and then receiving the signals from the output port of the discriminator with increased extinction ratio.

In certain exemplary embodiments one or more of the filters of the multi-filter discriminator is adapted to provide dispersion compensation, such as compensation for at least a portion of the chromatic dispersion in an optical fiber or other transmission fiber or waveguide optically coupled to the discriminator, e.g., an optic fiber coupled to the output port of the discriminator to transmit the optical signals to a receiver.

In accordance with certain exemplary embodiments, an optical dual filter discriminator for optical signals from a DML uses two thin film coupled cavity band pass or edge pass filters with offset center wavelengths in transmission and reflection to achieve improved extinction ratio and desired chromatic dispersion compensation for an intended optical fiber associated or intended eventually to be associated with the dual discriminator, e.g., in a telecommunication system. One of the filters receives the desired wavelengths passed or reflected by the other filter. As discussed further below, at least one of the filters transmits the desired wavelengths or channel and reflects the undesired wavelengths; the second filter either transmits the desired wavelengths and reflects the undesired wavelengths or visa versa.

The multiple filters of the optical discriminators disclosed here may be mounted or “packaged” together in a single housing, optionally along with one or more other features or components such as mounting fixtures, lenses, ferrules, taps, monitoring ports, etc. In certain exemplary embodiments the multiple filters and some or all of such other components are packaged together in a single, hermetically sealed housing. In that regard it should be recognized that the optical path in any particular embodiment of the multi-filter discriminators disclosed here may include also some or all such other components. That is, the optical path through the discriminator or from one lens to another of the discriminator may include other optical components, for example, lenses, ferrules, taps, monitors, etc. It should be understood, therefore, that segments of the optical path mentioned here and in the appended claims may in some cases (without necessarily being expressly stated) include passing through or being reflected by or otherwise being treated by other components of the discriminator. For example, transmission from the input port to the first filter may be direct or indirect, i.e., it may involve or not involve passing through or being reflected by or otherwise treated by other components of the discriminator. In certain especially advantageous embodiments a laser is integrated with the multiple filters into a common housing, again, optionally along with such other components.

In accordance with certain exemplary embodiments, optical dual filter discriminators or dual discriminators employ thin film coupled cavity band pass filters, especially with a DML signal source, e.g., an integrated DML, for high extinction ratio and dispersion compensation suitable for transmission of optical signals in an ITU C-band channel at transmission rates of 10 GHz/s or higher over 200 km or farther without intermediate signal amplification, for bit error rates (BER) less than 10⁻⁹-10⁻¹² or better. Alternative embodiments may employ edge pass filters, e.g., a thin film coupled cavity long pass filter in combination with a thin film coupled cavity long pass filter, either one being the first filter, depending on their cutoff wavelengths. Alternative embodiments may employ fiber Bragg Gratings with or in lieu of thin film coupled cavity filters.

In accordance with one aspect, an optical multi-filter discriminator comprises a first optical filter, a second optical filter optically coupled to the first optical filter, an input port operative to receive optical signals from an optical signal source and oriented to launch the optical signals directly or indirectly to the first optical filter, and an output port oriented to receive optical signals treated by the multiple optical filters and operative to pass the optical signals directly or indirectly to an optical waveguide “downstream” of the discriminator. The first filter is transmissive (i.e., at the angle of incidence received from the input port) of at least a first wavelength band having a first center wavelength and reflective (again, meaning in this instance at the angle of incidence received from the input port) of at least a second wavelength band different from the first wavelength band. The optical multi-filter discriminator defines an optical path for optical signals in the first wavelength band received by the input port. The optical path includes at least (i) transmission from the input port directly or indirectly to and through the first optical filter, and (ii) then, prior to the output port, from the first optical filter directly or indirectly to the second optical filter at an angle of incidence at which the second optical filter is reflective of the first wavelength band.

In accordance with one aspect, an optical multi-filter discriminator comprises a first optical filter, a second optical filter optically coupled to the first optical filter, an input port operative to receive optical signals from an optical signal source and oriented to launch the optical signals to the first optical filter, and an output port oriented to receive optical signals treated by the multiple optical filters and operative to pass the optical signals to an optical waveguide “downstream” of the discriminator. The first filter is transmissive of a first wavelength band having a first center wavelength and reflective of a second wavelength band having a second center wavelength different from the first center wavelength. The optical multi-filter discriminator defines an optical path for optical signals in the first wavelength band received by the input port. The optical path includes at least transmission from the input port to the first optical filter and through the first filter to the second optical filter prior to the output port. In certain exemplary embodiments the second optical filter is reflective of the second wavelength band and transmissive of the first wavelength band, and the optical path for optical signals in the first wavelength band further comprises transmission through the second optical filter (directly or indirectly) to the output port. In certain other exemplary embodiments the second optical filter is transmissive of the second wavelength band and reflective of the first wavelength band, and the optical path in such embodiments for the first wavelength band further comprises reflection from the second optical filter back to the first optical filter and optionally then again through the first optical filter to the output port.

In certain exemplary embodiments of the optical multi-filter discriminators disclosed here, the multiple optical filters each may be a thin film filter, such as a Fabry-Perot filter formed, e.g., by sputter deposition or in accordance with other known techniques, on the surface of an optical substrate, typically glass or the like that is transparent to the first wavelength band, i.e., to the wavelength(s) of the desired optical signals. The first such optical filter can be disposed on a surface of a first optical substrate, and the second optical filter can be disposed on a surface of a second optical substrate, and so on. In certain other exemplary embodiments the first optical filter is disposed on a first surface of an optical substrate, and the second optical filter is disposed on a second surface of the same optical substrate, such as the opposite surface of the substrate. The optical filters each may be, for example, a band pass filter, a notch filter, etc. or they may be a complimentary set of a high pass and a low pass filter, etc. In this respect, it will be understood by those skilled in the art that the filters are interfering. That is, they have transmission characteristics that are different from each other and cooperate to define the desired wavelength band or channel.

In accordance with another aspect, an optical communication system comprises an optical signal source operative to generate optical signals and one or more optical multi-filter discriminators, as disclosed above, optically coupled to the optical signal source. The optical signal source may comprise one or more lasers, such as directly modulated lasers. The laser(s) optionally are mounted in a single, hermetically sealed housing with the multiple optical filters of the discriminator. Such integrated embodiments provide compactness and economy advantageous for certain applications.

In accordance with another aspect, a method of operating an optical communication system comprises generating optical signals by modulating input current to an optical signal source, passing the optical signals to the input port of an optical multi-filter discriminator as disclosed above, and, following processing, if any, by optional additional optical filters of the optical multi-filter discriminator, passing the optical signals to a second optical waveguide, e.g., an optical fiber, via an output port of the optical multi-filter discriminator. The optical signals received from the optical multi-filter discriminator are then carried to a receiver at least in part via the second optical waveguide. In certain exemplary embodiments the first center wavelength, which is passed by the first optical filter, and the second center wavelength which is reflected by the first filter, are in the C-band, L-band, or S-band, etc. In certain exemplary embodiments of such methods disclosed here, a dual discriminator employs a pair of band pass filters wherein the first center frequency is from 2 GHz to 25 GHz or more away from the second center frequency, e.g., 2.2 GHz away, 5 GHz away, 10 GHz away, etc. In certain exemplary embodiments the first 3 dB down wavelength pass band (i.e., the pass band of the first filter) is from 1549.89 nm to 1549.97 nm and the 3 dB down wavelength pass band (i.e., the pass band of the second filter) is from 1549.80 nm to 1549.88. (See, e.g., FIG. 5.) In certain exemplary embodiments, processing the optical signals through the optical multi-filter discriminator increases the extinction ratio from a value less than 5 dB, e.g., between 2 dB and 5 dB to a value above 5 dB, e.g., a value of 20 dB or more.

Those of ordinary skill in the art will recognize that various embodiments of the optical multi-filter discriminators, optical communication systems and methods of operating an optical communication system disclosed here represent a significant technological advance and can provide significant advantages. For certain exemplary embodiments these advantages stem at least in major degree from the double pass transmission and reflection processing by dual filter processing of the optical signals in a compact package. Such advantages for at least certain exemplary embodiments include significantly increased extinction ratio. Also, good design flexibility and performance are afforded in the multi-filter design for providing chromatic dispersion compensation. More generally, it will be recognized from this disclosure and the following description of certain exemplary embodiments, that optical multi-filter discriminators and optical signal systems can be achieved which are compact, have good performance, such as high extinction ratio and low bit error rate probabilities, are economical to produce or have a combination of two or more of these advantages. Additional and optional features and advantages of the invention will be apparent from the following disclosure of certain preferred and exemplary embodiments. It will be recognized by those skilled in the art, given the benefit of this disclosure, that there are numerous alternative embodiments of the systems, devices and methods disclosed here for treating or processing optical signals. Various especially preferred embodiments have advantageous use in fiber optic telecommunication systems or other optical signal systems.

### BRIEF DESCRIPTION OF THE DRAWINGS

Various aspects and features of the inventive subject matter disclosed here are further disclosed and described below with reference to the appended drawings wherein:

FIG. 1 is a schematic illustration of an optical dual discriminator in accordance with certain exemplary two-port embodiments of the inventive subject matter of the present disclosure;

FIG. 2 is a graph of the simulated spectra of a directly modulated laser, shown here modulated at 2.2 GHz;

FIG. 3 is a schematic illustration of a chip layout in accordance with certain exemplary embodiments of the inventive subject matter of the present disclosure, suitable for the optical dual discriminator of FIG. 1;

FIG. 4 is a schematic illustration of optical path angles for a chip layout suitable for the optical dual discriminator of FIG. 1;

FIG. 5 is a graph showing transmission profiles for the filter chips of an exemplary optical dual discriminator in accordance with FIGS. 1-4;

FIG. 6 is a schematic illustration of a component layout for an exemplary optical dual discriminator in accordance with FIGS. 1-5, where the dual discriminator is packaged as a separate component from a laser signal source and where, for simplicity of illustration, selected components, e.g., a housing, etc. are not shown;

FIG. 7 is a schematic illustration of a component layout for an exemplary optical dual discriminator in accordance with FIGS. 1-5, where the dual discriminator is integrated into a laser package and where, for simplicity of illustration, selected components, e.g., a housing, ferrules, etc. are not shown;

FIG. 8 is a schematic illustration of a two port optical dual discriminator in accordance with certain other exemplary embodiments of the inventive subject matter of the present disclosure;

FIG. 9 is a schematic illustration of a chip layout in accordance with certain exemplary embodiments of the inventive subject matter of the present disclosure, suitable for the optical dual discriminator of FIG. 8, where two optical chips each carries one of the two thin film filters of the dual discriminator;

FIG. 10 is a schematic illustration of a component layout for an exemplary optical dual discriminator in accordance with FIGS. 8 and 9, where, for simplicity of illustration, selected components, e.g., a housing, etc. are not shown;

FIG. 11 is a graph showing theoretical transmission and reflection plots for each of the two filter chips of an exemplary optical dual discriminator in accordance with FIGS. 8-10, along with a superimposed trace of the DML output showing an approximately 160 pm shift between the null or space and the mark or 1s expected for a 10 GHz optical signal system, where the first filter is tuned to transmit wavelengths near the 1s and to reflect wavelengths near the 0s.

FIG. 12 is a schematic illustration of a chip layout in accordance with certain exemplary embodiments of the inventive subject matter of the present disclosure, suitable for the optical dual discriminator of FIGS. 8-11;

FIG. 13 is a graph showing the theoretical and measured transmission for an exemplary optical dual discriminator in accordance with FIGS. 8-12;

FIG. 14 is a graph showing the chromatic dispersion (CD) profile for the first and second filters of a dual discriminator in accordance with FIGS. 8-13, including a negative CD region for the first filter; and

FIG. 15 is a schematic illustration of a component layout for an alternative exemplary optical dual discriminator in accordance with FIGS. 8 and 9, having a monitor port, where, for simplicity of illustration, selected components, e.g., a housing, etc. are not shown.

The appended drawings briefly described above are exemplary of the inventive subject matter disclosed here and claimed in the appended claims. Innumerable alternative embodiments will be apparent to those of ordinary skill in the art given the benefit of this disclosure.

### DETAILED DESCRIPTION OF EXEMPLARY EMBODIMENTS

It will be understood by those skilled in the art, that various different embodiments of the systems, devices and methods disclosed here for treating or processing optical signals have numerous uses and applications. For purposes of illustration and not limitation, the further disclosure and description below focus mainly on a fiber optic system, such as a telecommunication system. At least certain of the exemplary embodiments of the invention in the following discussion are suitable for optical signal systems employing DMLs and the like. Certain embodiments disclosed here are suitable for use in other optical systems. Certain of the embodiments disclosed here are suitable for dense wavelength division multiplexed telecommunications systems operating in the C-band. However, it will be readily apparent to those skilled in the art, given the benefit of this disclosure, that at least certain exemplary embodiments of systems, devices and methods in accordance with the principles disclosed here have application within the scope of the invention to other optical systems, including telecommunications systems operating in other wavelength bands or using other components.

As used here and in the appended claims, optical elements of a system, device or method in accordance with the present disclosure, e.g., optical components or features such as optical discriminators for signals generated by a DML, gain-flattening filters, optical amplifiers, isolators, multiplexers, collimators, etc., are “in optical series” along an optical pathway when they are optically coupled to one another so that one can pass optical signals to the other or receive optical signals passed by the other. Components are in optical series with one another along the optical pathway when they are optically coupled to each other so as to be operative to pass or propagate optical signals from one to the other (directly or indirectly) along the optical pathway traveled by the optical signals in the ordinary proper functioning of the system, device or method. Optical elements are in optical series with one another regardless whether they are upstream or downstream of one another along the optical pathway. Optical elements are optically coupled to one another directly in an arrangement wherein one can pass optical signals to the other or receive optical signals passed by the other with no intervening optical elements (other than free space or a passive waveguide or the like). Optical elements are optically coupled to one another indirectly in an arrangement wherein one can pass optical signals to the other or receive optical signals passed by the other with one or more other optical elements in the series intervening between them, e.g., an isolator, active waveguide (e.g., a coil of erbium doped fiber), a fused fiber mux or other multiplexer, etc. Thus, a component is in optical series with another component when it is arranged or operative to pass optical signals to the other component, either directly or indirectly (or to receive optical signals from the other component, again, either directly or indirectly).

It will be understood by those skilled in the art, given the benefit of this disclosure, that a first component is “upstream” of a second component in the same system, device or method when optical signals are passed, tapped, sampled, reflected or otherwise processed by the first component prior to being processed by the second component as the optical signals travel along the intended optical path through the system, device or method during proper operation thereof. Likewise, the second or subsequent component is “downstream” of the first component.

The choice of optical signal source may or may not be critical to a particular application of an optical multi-filter discriminator in accordance with this disclosure. Suitable DMLs and other laser signal sources and other optical signal sources for use in various applications of the systems, devices and methods disclosed here are commercially available and will be apparent to those skilled in the art, given the benefit of this disclosure. Likewise, the precise wavelength(s) emitted by the optical signal source may or may not be critical to the particular application. Given the benefit of this disclosure, it will be within the ability of those skilled in the art to select a DML or other optical signal source and associated components suitable to the intended application.

It will also be recognized by those skilled in the art, given the benefit of this disclosure, that alternative and/or additional components may be employed in certain embodiments of the systems, devices and methods disclosed here. Alternative and additional components include those presently known and those developed over time in the future. Multiple ferrule designs are known, for example, and it will be within the ability of those skilled in the art, given the benefit of this disclosure, to select and employ suitable ferrules, if any, in various different embodiments of the systems, devices and methods disclosed here. Likewise, multiple alternative designs are known for collimating lenses and other lenses which may be used, including ball lenses, GRIN lenses, barrel lenses, aspherical lenses, etc. In certain exemplary embodiments an optical multi-filter discriminator along with other components, e.g., lenses, ferrules, etc., necessary or useful for the particular application may be housed in a single housing, typically, e.g., a hermetically or environmentally sealed housing, or in multiple housings. Alternatively, in accordance with certain exemplary embodiments some or all of the components may be unhoused. Certain of the components optionally are packaged separately for convenience of manufacture or use, e.g., to facilitate access to the signals for monitoring, system management or other reasons. Within a housing, sub-assemblies of components may be packaged within sub-housings. In general, it will be understood by those skilled in the art, given the benefit of this disclosure, that packaging of various embodiments of the components of systems, devices and methods disclosed here can typically employ a housing similar in design or principle, for example, to the housings currently used for other fiber optics devices, e.g., commercial Dense Wavelength Division Multiplexer (DWDM) filters, etc. Also suitable as a housing are, e.g., housings similar in design to those used as the hermetically sealed housings of external modulated lasers, direct modulated lasers, TOSAs, etc. The discriminator can be packaged into the current laser housing to achieve good compactness and economics.

Thin-film filters employed in systems, devices and methods disclosed here, e.g., the filters, anti-reflection (A/R) coatings, etc., can be designed and manufactured in accordance with any suitable technology, equipment and techniques now known or known in the future. Suitable filters can be designed in accordance with current techniques, e.g., using commercially available software, such as Essential Macleod software, a comprehensive software package for the design and analysis of optical thin films, TFCalc from Software Spectra Inc., etc. Suitable filters can be manufactured in accordance with various currently known techniques, such as sputtering evaporation, electron beam gun evaporation, ion-assisted evaporation coating techniques, etc. Numerous suitable materials and manufacturing techniques are commercially available and will be readily apparent to those skilled in the art, given the benefit of this disclosure.

Optionally one or more diagnostic features may be incorporated into the systems, devices and methods disclosed here. For example, one or more optical taps may be incorporated for performance monitoring. Such optical tap may comprise, for example, a photo diode or merely an optical fiber to feed optical information to a remote location, i.e., to a receptor at a location outside the housing (if any) of the optical discriminator.

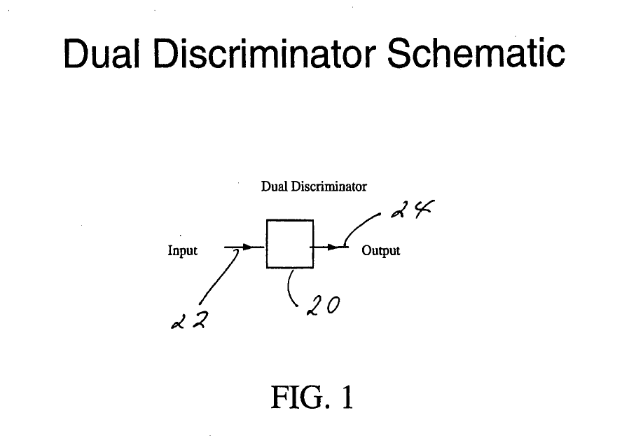

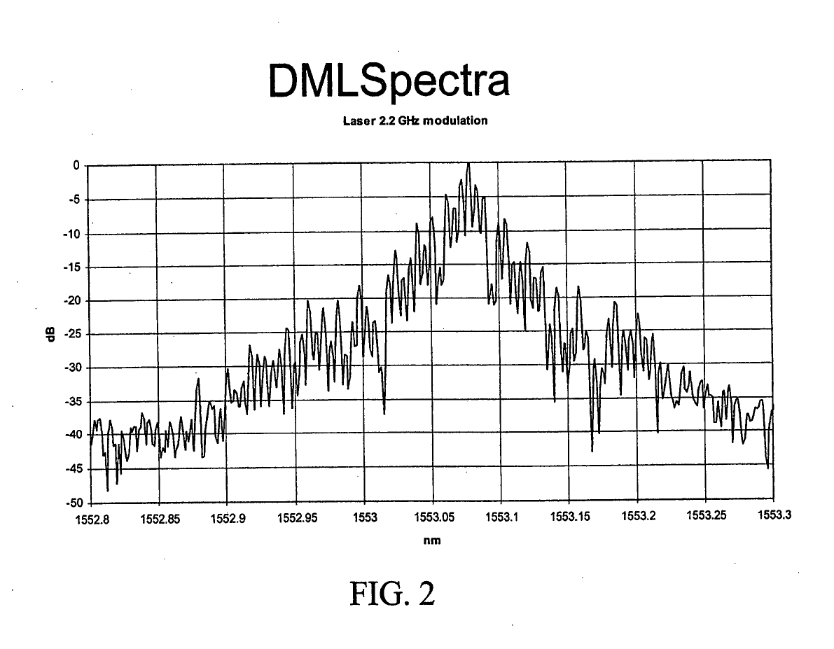

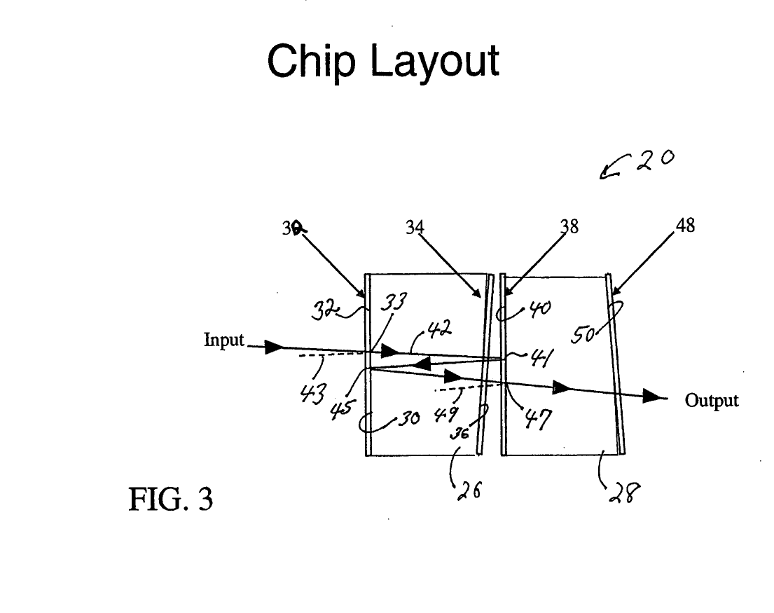

Referring now to the drawings, FIGS. 1-7 relate to certain exemplary embodiments of optical dual discriminators in accordance with the inventive subject matter disclosed here. FIG. 1 shows schematically a dual discriminator 20 in accordance with the present invention, having input port 22, and output port 24. Both input port 22 and output port 24 may comprise, for example, optical fibers extending in a ferrule from outside the dual discriminator into a housing in which the two filters of the dual discriminator are mounted. The optical dual discriminator 20 is suitable for use, for example, with an optical signal source comprising a DML laser, such as one having the spectra shown in FIG. 2. FIG. 3 illustrates schematically a chip layout suitable for use in discriminator 20. As seen in FIG. 3, a first optical substrate 26 is positioned adjacent a second optical substrate 28. First optical substrate 26 carries on its first or upstream surface 30 a thin-film filter, specifically, bandpass filter 32. At the angle of incidence of optical path 42 when it first reaches filter 32 (illustrated as point 33 on filter 32), e.g., as launched from an input port of the dual discriminator, bandpass filter 32 is transmissive of a first wavelength band or center wavelength corresponding to a desired signal channel, e.g., an ITU channel in a wavelength division multiplexed optical signal system. At that angle of incidence, bandpass filter 32 is reflective of wavelengths adjacent to but outside of the first wavelength band, e.g., to Chirp wavelengths of the optical signal coming from a DML. In FIG. 3 dashed line 43 represents the component which is removed from the input by reflection at filter 32 at point 33. Substrate 26 has antireflective film 34 on its second or downstream surface 36. Optical substrate 28 carries a second bandpass filter, specifically, bandpass filter 38 on its upstream surface 40. Bandpass filter 38 is reflective of the aforesaid first wavelength band at the angle of incidence when the optical path 42 first reaches bandpass filter 38 (illustrated as point 41 on filter 38). At that angle of incidence, bandpass filter 38 is also reflective of wavelengths adjacent to but outside of the first wavelength band. Optical substrate 28 carries antireflective film 48 on its second or downstream surface 50.

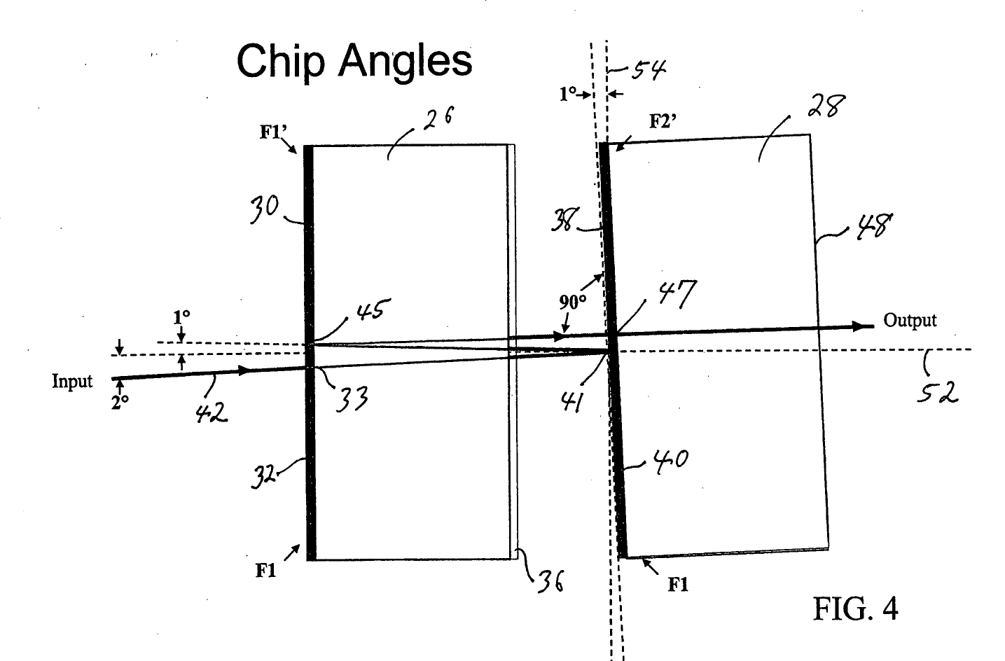

As best seen in FIG. 4 (shown inverted or upside down relative to the orientation of FIG. 3) surface 40 of substrate 28 is angled relative to surface 30 of substrate 26, that is, they are not in parallel planes. For purposes of this description, surface 30 is square to the X axis 52 and Y axis 54 shown in FIG. 4, that is, it is parallel to the Y axis and perpendicular to the X axis. In the illustrated embodiment, surface 40 is canted or angled 1° relative to surface 30 and Y axis 54. As a result of the canted filter surfaces 30 and 40 and the design of the filters, bandpass filter 32 is reflective of the aforesaid first wavelength bandpass at the angle of incidence when optical path 42 reaches bandpass filter 32 for the second time (illustrated as point 45 on filter 32). At that angle of incidence, bandpass filter 32 is transmissive of wavelengths adjacent to but outside of the first wavelength band, e.g., to chirp wavelengths of the optical signal coming from a DML, and that component is further removed from the signal by transmission through filter 32 at point 45. Similarly, bandpass filter 38 is transmissive of the first wavelength band at the angle of incidence when optical path 42 reaches bandpass filter 38 for the second time (illustrated as point 47 on filter 38). At that angle of incidence, bandpass filter 38 is reflective of wavelengths adjacent to but outside of the first wavelength band. In FIG. 3 dashed line 49 represents the component which is removed from the input by reflection at filter 38 at point 47. It will be within the ability of those of ordinary skill in the art, given the benefit of this disclosure, to select suitable angles and filter designs to achieve differential transmissivity (i.e., transmissivity at the first angle of incidence and reflectivity at the second angle of incidence, or visa versa) suitable for a particular intended application.

Thus, in the illustrated embodiment (although not necessarily in all embodiments) the optical path intersects twice each of the two filters, removing a substantial portion of undesired wavelengths in the optical signals (e.g., “chirp” wavelengths). The wavelength band of the desired optical signal is passed once each through first filter 32 and second filter 38 and is reflected once each by each of the filters in the dual discriminator. The result in well designed embodiments is excellent improvement of the extinction ratio.

Optionally, the filters are designed to provide chromatic dispersion compensation for an associated optical fiber of the system or other waveguide. The two or more filters of the optical discriminator and the multiple intersections or bounces afford good design flexibility to achieve a desired degree of chromatic dispersion compensation along with good extinction ratio. Significant advantage is achieved by having multiple bounces, since, e.g., one of the filters can be optimized for chromatic dispersion and the other for extinction ratio.

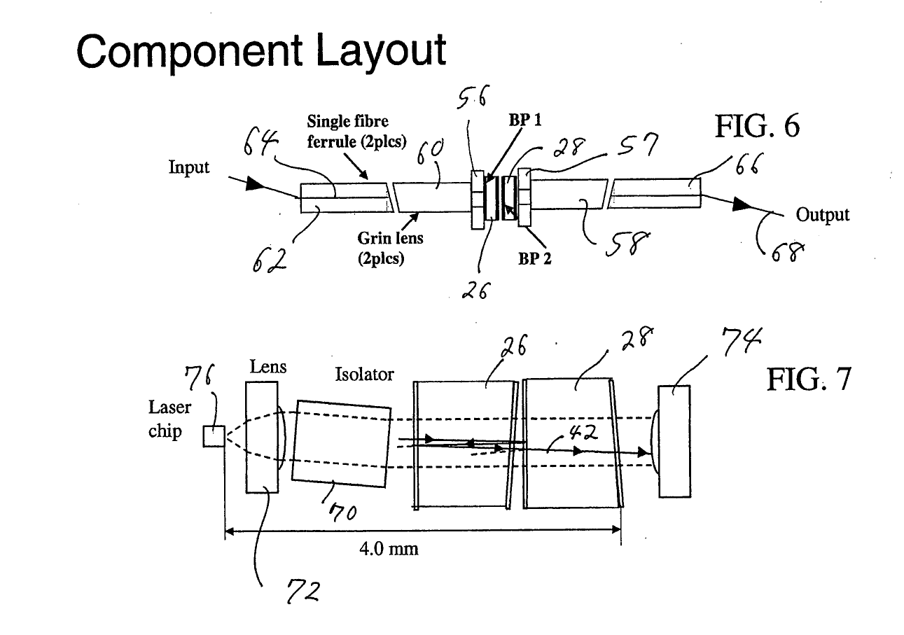

Referring now to FIG. 6, a component layout is seen for an optical dual filter discriminator in accordance with FIGS. 1-4. The dual discriminator of FIG. 6 comprises optical chip 26 and optical chip 28 as shown in FIGS. 3 and 4. Mounting fixtures 56 and 57 are provided for mounting the filter chips, and/or lenses 58 and 60. It will be within the ability of those skilled in the art to design suitable mounting fixtures for the multiple filters and other components employed in the dual discriminator. Ferrule 62 is seen to provide input fiber 64. In the embodiment of FIG. 6, ferrule 62 is a single fiber ferrule. Similarly, ferrule 66 is a single fiber ferrule providing output optical fiber 68. It will be apparent to those skilled in the art that the components shown in FIG. 6 can be readily housed hermetically in a barrel or tube-shaped housing in accordance with known techniques. It will be within the ability of those skilled in the art to employ alternative suitable housings.

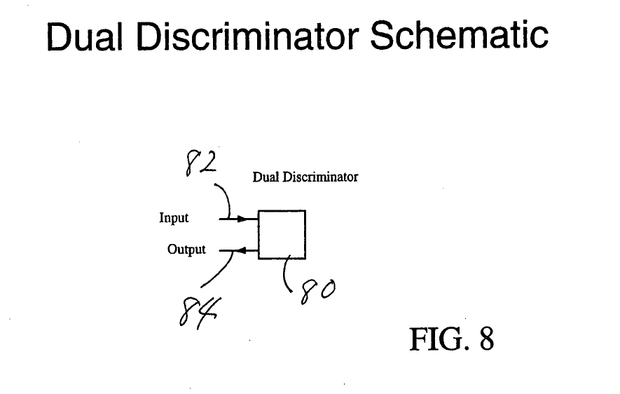

FIG. 7 illustrates a component layout wherein the dual filter discriminator is integrated with an optical signal source, specifically, a laser chip, such as a semiconductor laser. While exemplary dual discriminators in accordance with this disclosure may be about 2.0 mm in overall length, FIG. 7 shows an exemplary 4.0 mm size for an optical substrate for the dual discriminator portion of the device plus the lens and isolator which would typically be present in a laser housing. In the embodiment of FIG. 7, an isolator 70 is positioned between the lens 72 and first filter substrate 26. An output port lens 74 is provided downstream of the second optical substrate 28. Laser chip 76 is provided upstream of first lens 72. The isolator and lens can be combined, e.g., as in an OASIS device (Lightpath Inc., Orlando, Fla.).

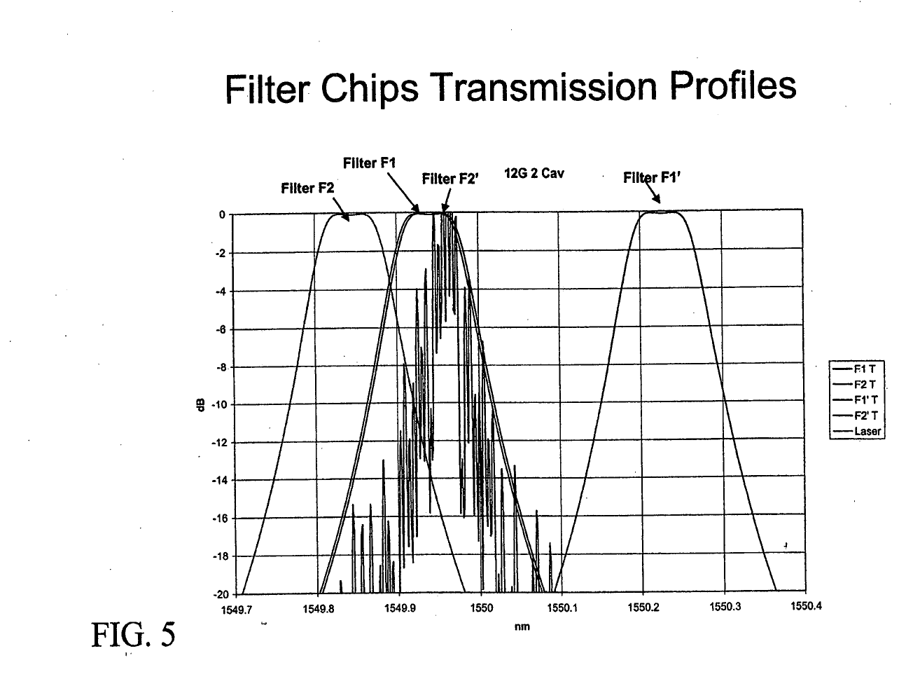

FIG. 5 is a graph showing transmission profiles for the filter chips of an exemplary optical dual discriminator in accordance with FIGS. 1, 3, 4 and either 6 or 7. It can be seen that transmission through the first filter (filter 32 in FIGS. 3 and 4) provides good extinction ratio and transmission through the second filter (filter 38 in FIGS. 3 and 4), following reflection at both filters, provides excellent extinction ratio. The first transmission through the second filter and the second transmission through the first filter are seen to remove undesired wavelengths, e.g., chirp wavelengths or wavelengths corresponding to 0s in the optical system. As a result, excellent long distance transmission can be achieved and low bit error rates with less or no intermediate amplification. It can be seen also, that compact packaging of the two filters into a single housing can be readily accomplished. In certain exemplary embodiments the two filters can be disposed on opposite surfaces of a single optical substrate, e.g., a single chip, thereby affording in some well designed embodiments an advantageous, highly compact design.

In operation of dual discriminator 20, laser signal source output is collimated; optionally it also is sent through an isolator. The laser may, for example, be modulated at 2.2 GHz. The optical beam, optionally, for example, having a nominal 12.5 GHz bandwidth (40 pm) or 25 GHz bandwidth (200 pm), is then incident on the first filter. In this exemplary embodiment, the optical beam is incident on the first filter at an angle of 2°, whereby the filter response is shifted downscale approximately 383 pm from the response at normal incidence. In this arrangement, the first filter is tuned to transmit the mark (1) and to reflect the space (0) components of the modulated laser output. The portion of the optical beam transmitted through the first filter is then incident on the second filter. The second filter in this exemplary embodiment can be identical to the first filter except that it is tuned down by 95 pm. The second filter is tilted or angled toward the first filter by 1°. Thus, the optical beam is incident on the second filter at 1°. Both the mark and the space portions of the signal are reflected at this point by the second filter in this exemplary embodiment. The optical beam reflected from the second filter is then incident again on the first filter, this time at an angle of incidence of 1° rather than 2°. Therefore, the response of the first filter is shifted upscale by 288 pm (relative to the first pass of the optical path through the first filter). Accordingly, both the mark and the space portions of the signal are reflected at this point by the first filter. In this regard it can be noted that angle tuning is non-linear. The optical path from the reflection at the first filter is then again, incident on the second filter. In this second instance, the optical beam is normal to the second filter. Therefore, the filter response is shifted upscale by 95 pm (relative to the first time the optical path reached the second filter). At normal incidence, the second filter is tuned to transmit the desired wavelengths, that is, the marks or 1s and to reflect the 0s.

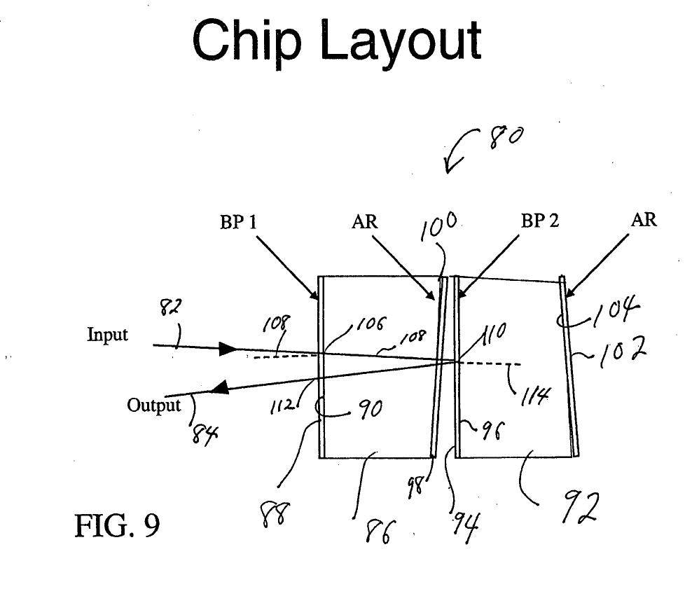

FIGS. 8-14 relate to alternative embodiments wherein the input and output ports of the dual discriminator are co-positioned. That is, the output port feeds the optical signals, after they are processed by the discriminator, out of the discriminator in a direction opposite to that of the input port. Thus, in FIG. 8, dual discriminator 80 is seen to have input port 82, feeding optical signals from the left (in the arbitrary orientation illustrated in FIG. 8) and output port 84, feeding processed optical signals back to the left, e.g., via an optical fiber extending parallel to an input fiber in the same ferrule. In the chip layout of FIG. 9, a first or upstream optical substrate 86 carries first filter 88 on surface 90. Second, optical substrate 92 carries second filter 94 on surface 96. First, substrate 86 has an antireflective film 98 on opposite surface 100 and, similarly, substrate 92, has antireflective film 102 on its downstream surfaced 104. As in the previous embodiment, filters 88 and 94 are bandpass filters. However, it will be apparent to those skilled in the art, given the benefit of this disclosure, that edge pass filters or other filter types may be employed. It can be seen that surface 100 of upstream optical chip 86 is canted or angled to prevent an etalon effect between the two filter chips.

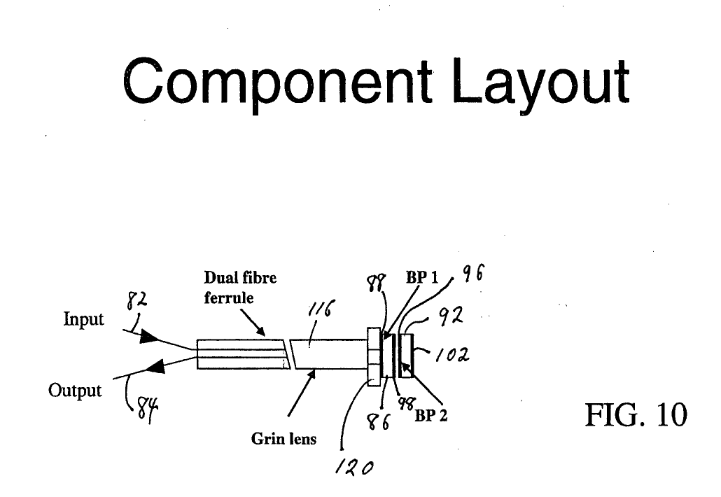

First optical filter 88 is transmissive of the desired wavelengths or wavelength band. At point 106 optical path 108 is shown to pass through filter 88 to filter 94 of the second chip. Dashed line 108 represents the reflection of unwanted components of any optical signal received from the optical signal source, e.g., a DML. Optical filter 94 is reflective of the desired wavelength band and accordingly reflects the optical signals at point 110. Specifically, the desired wavelength band is reflected back through first filter 88 at point 112 dashed line 114 represents transmission through filter 94 of unwanted components of the input optical signal. Thus, the extinction ratio of optical signals processed by dual discriminator 80 is improved by both transmission and reflection, specifically, transmission twice through first optical filter 88, and reflection once at second optical filter 94. In the component layout schematically illustrated in FIG. 10, dual discriminator 80 is seen to further comprises a grin lens 116 to focus optical signals from input port 82 to filter 88, and to focus signals from filter 88 (after processing by the two optical filters) to output port 84. Mounting means 120 is provided for mounting the optical substrate ships carrying the two filters, the grin lens and other components, if any, included in the housing, if any, of the discriminator.

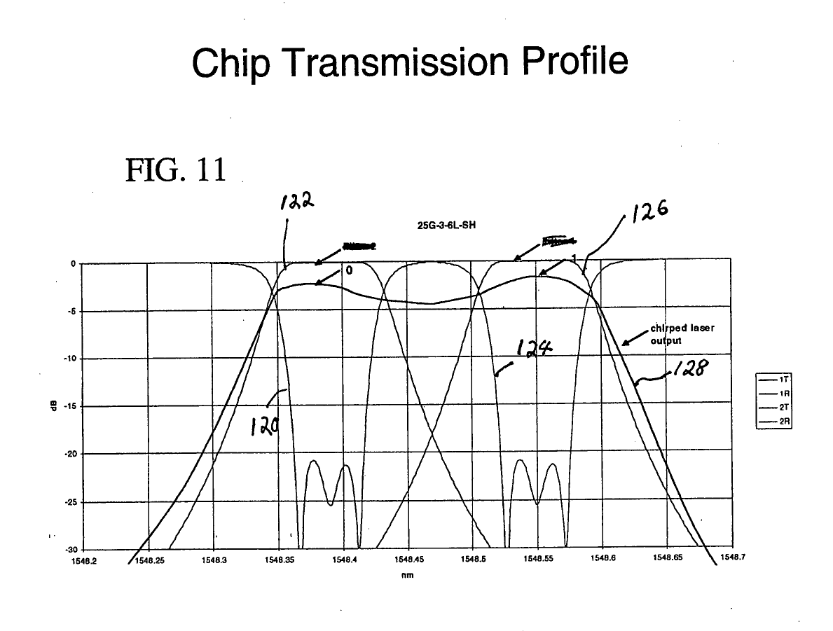

FIG. 11 is a graph showing theoretical transmission and reflection plots for each of the two filter chips of an exemplary dual discriminator in accordance with FIGS. 8-10, along with a superimposed trace of the DML output showing an approximately 160 pm shift between the null or space and the mark or 1s expected for a 10 GHz optical signal, where the first filter is tuned to transmit the desired wavelengths of the 1s and to reflect the unwanted signal components corresponding to 0s. Any optical signal transmitted through the first filter is applied to the second filter. The second filter is tuned to reflect the desired wavelengths of the 1s and to transmit the unwanted signal components corresponding to 0s. The signal components reflected from the second filter are transmitted back through the first filter and aligned with the output port. This achieves a high extinction ratio. As noted above, identical or different, bandpass filters may be employed with angle tuning, and alternatively edge pass or other filter types may be employed. Trace 120 represents performance of filter 1 in reflection. Trace 122 represents performance of filter 1 in transmission. Trace 124 represents performance of filter 2 in reflection. Trace 126 represents performance of filter 2 in transmission. Trace 128 represents the chirped output of an optical signal source comprising a DML. The right-side peak having a center wavelength at about 1548.55 corresponds to 1s or the mark. The left-side peak having a center wavelength at about 1548.37 corresponds to 0s or the nulls.

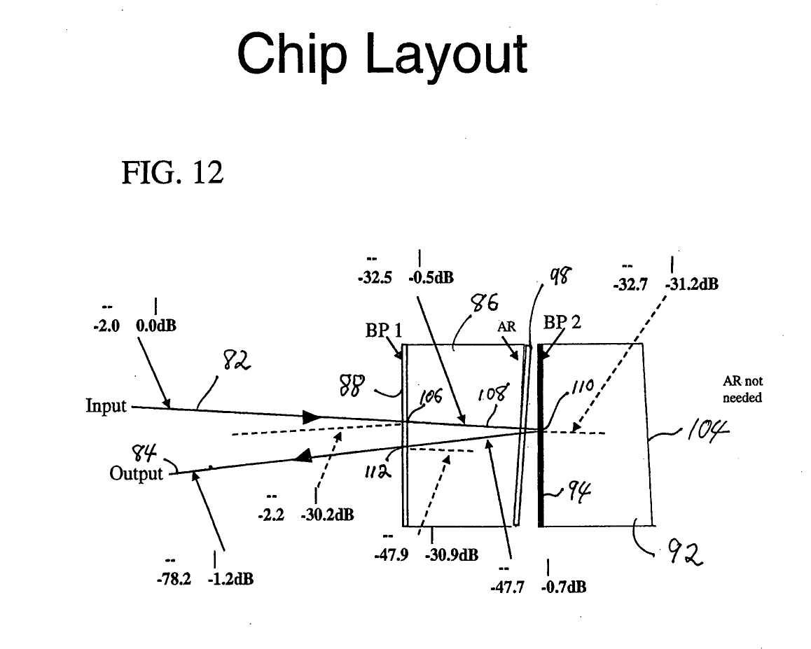

FIG. 12 is a schematic illustration of a chip layout in accordance with certain exemplary embodiments of the inventive subject matter of the present disclosure, suitable for the optical dual discriminator of FIGS. 8-11. FIG. 12 shows the signal trace or optical path through the dual discriminator along with individual and cumulative insertion losses along the optical path for both the mark, that is, the desired pass band or channel, and the null, that is, the wavelengths or signal components adjacent to the mark, represented in FIG. 12 as “|” and “--”, respectively. It is assumed for FIG. 12 that (a) the DML signal source's output peaks at 0 dB for the mark (1) and −2 dB for the null (0), (b) insertion loss (IL) is 0.5 dB in transmission (T) and 0.2 dB in reflection (R), and (c) there is −15 dB isolation in the pass band (PB) and −30 dB isolation at 160 pm away from the pass band. Thus, as shown in FIG. 12, after the first filter 88 (past point 106) in transmission the mark is 0.5 dB down, i.e., −0.5 dB, and the null is −32.5 dB; in reflection the mark is −30.2 dB and the null is −2.2 dB. After the second filter 94 (past point 110) in transmission the mark is −31.2 dB and the null is −32.7 dB; in reflection the mark is −0.7 dB and the null is −47.7 dB. After the first filter for the second time (past point 112) in transmission the mark is −1.2 dB and the null is −78.2 dB; in reflection the mark is −30.9 dB and the null is −47.9 dB. It can be seen therefore, that excellent improvement in the extinction ratio can be achieved with certain exemplary embodiments of the optical multi-filter discriminators disclosed here and optical systems employing them.

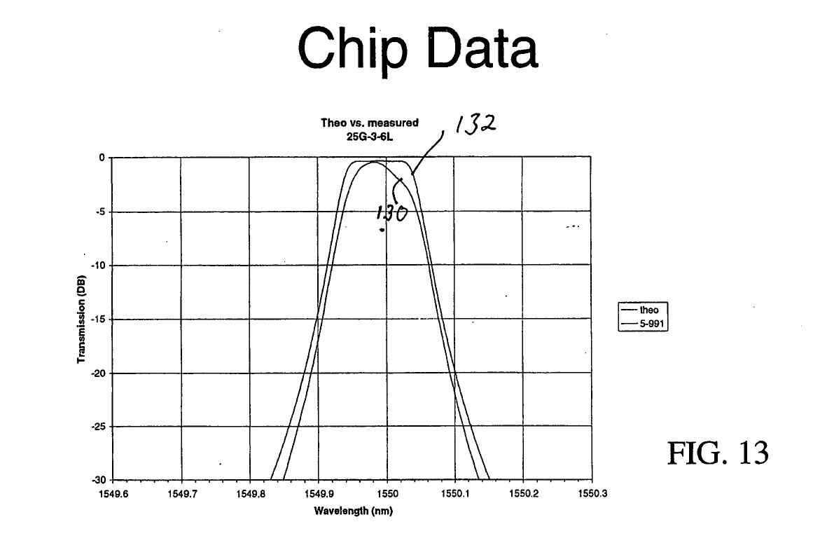

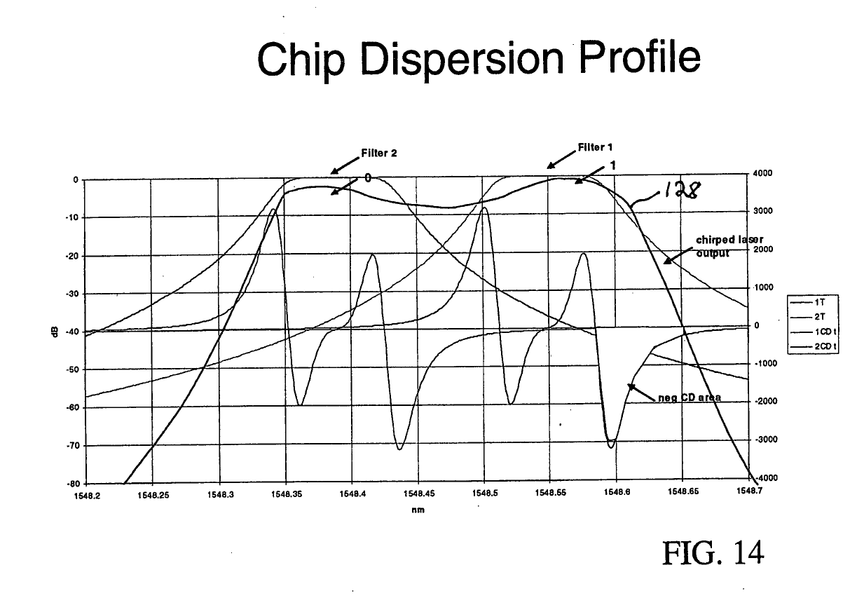

FIG. 13 is a graph showing the theoretical and measured transmission for an exemplary optical dual discriminator in accordance with FIGS. 8-12. It can be seen that the measured performance of this embodiment, represented by line 130 corresponds well with theoretical transmission, represented by line 132. FIG. 14 illustrates that a large amount of chromatic dispersion compensation can be provided by optical multi-filter discriminators in accordance with this disclosure. In the embodiments of FIGS. 8-14 this is due, in part, to the signal passing twice through the first filter. In alternative embodiments, chromatic dispersion compensation can be provided by the second filter, a combination of the first and second filters, a third filter, etc. As in FIG. 11, trace 128 represents the chirped output of an optical signal source comprising a DML. The right-side peak having a center wavelength at about 1548.57 corresponds to 1s or the mark. The left-side peak having a center wavelength at about 1548.37 corresponds to 0s or the nulls. Transmission over a distance of 200 km of single mode optical fiber, such as smf28, at 17 ps/nm/km would amount to about 3400 ps/nm, which is about the value shown in FIG. 14. Those of ordinary skill in the art will recognize, given the benefit of this disclosure, that alternative filter designs and additional cascaded filters, e.g., additional filters the same as the first filter, are readily possible to customize the amount of chromatic dispersion compensation.

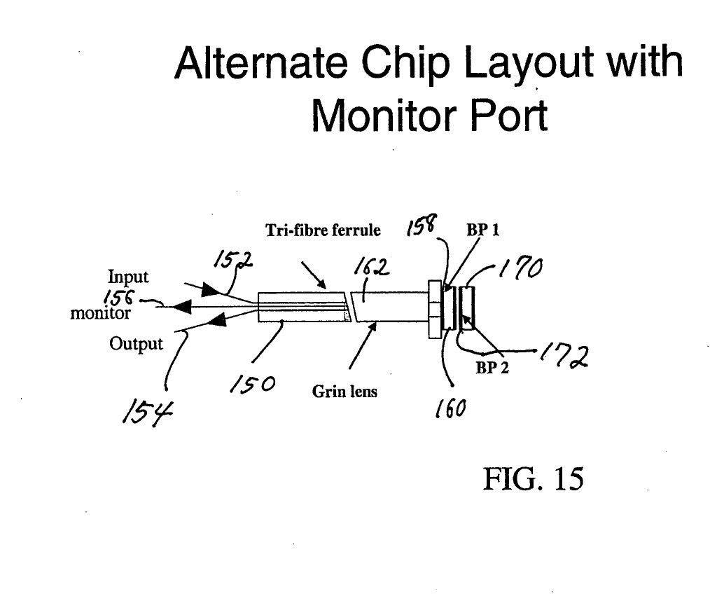

Certain embodiments of optical multi-filter discriminators in accordance with this disclosure incorporate monitoring and feedback features. Monitoring and feedback techniques suitable for incorporation in optical multi-filter discriminators in accordance with this disclosure are known and will be apparent to those of ordinary skill in the art given the benefit of this disclosure. In accordance with certain exemplary embodiments, an additional port is provided for monitoring and feedback. An additional port can be provided, for example, generally in accordance with the teachings of U.S. Pat. No. 4,805,235, the entire disclosure of which is incorporated herein by reference for all purposes. In certain exemplary embodiments an additional port for monitoring and feedback can be provided by using a 35 or ferrule and focusing the reflected null signals from the first optical filter on to the monitoring port. An alternative component layout in accordance with certain exemplary embodiments is schematically illustrated in section view in FIG. 15. In such embodiments it is seen that 835 or ferrule 150 provide a first optical fiber 152 to serve as an input port fiber, a second optical fiber 154 to serve as an output port fiber and a third optical fiber 156 to serve it as a monitor port. Although various alternative modes of operation are possible, in embodiments such as those of FIG. 15 the null wavelengths reflected from first filter 158 carried on first or upstream optical substrate 160 are focused by GRIN lens 162 into monitor five or 156. It will be recognized from this disclosure that it is necessary to align both checks 160, 170 independently for wavelength. In addition, the second optical filter 172, carried by ship 170, must be aligned to the reflection port. This can be accomplished, for example, by ferrule spacing and/or independent angle adjustments. Alternatively, the two optical chips 160, 170 can be bake tuned relative to each other and assembled and the unit. Additional alternative methods will be apparent to those skilled in the art given the benefit of this disclosure.

Given the benefit of the above disclosure and description of exemplary embodiments, it will be apparent to those skilled in the art that numerous alternative arrangements are possible in keeping with the general principles of the invention. For example, the multiple filters of the optical multi-filter discriminators may be positioned on surfaces of one or more optical chips differently than the arrangements shown in the illustrated embodiments.

It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc.

Although the present invention has been described in terms of specific exemplary embodiments, it will be appreciated that various modifications and alterations will be apparent from this disclosure to those skilled in the art, without departing from the spirit and scope of the invention as set forth in the following claims.

What is claimed is:

1. An optical multi-filter discriminator comprising:
a. a first optical filter transmissive of at least a first wavelength band having a first center wavelength and reflective of at least a second wavelength band different from the first wavelength band; and
b. a second optical filter optically coupled to the first optical filter; and
c. an input port operative to receive optical signals from an optical signal source and oriented to launch the optical signals directly or indirectly to the first optical filter; and
d. an output port oriented to receive optical signals treated by the first and second optical filters and operative to pass the optical signals directly or indirectly to an optical waveguide;
wherein the optical multi-filter discriminator defines an optical path for optical signals in the first wavelength band received by the input port, the optical path comprising:
from the input port directly or indirectly to and through the first optical filter, and
from the first optical filter directly or indirectly to the second optical filter prior to the output port, at an angle of incidence at which the second optical filter is reflective of the first wavelength band.

2. The optical multi-filter discriminator of claim 1 wherein the second optical filter is reflective of the second wavelength band and transmissive of the first wavelength band, and the optical path for optical signals in the first wavelength band further comprises transmission through the second optical filter to the output port.

3. The optical multi-filter discriminator of claim 1 wherein the second optical filter is transmissive of the second wavelength band and reflective of the first wavelength band, and the optical path for optical signals in the first wavelength band further comprises reflection from the second optical filter back to the first optical filter and then again through the first optical filter to the output port.

4. The optical multi-filter discriminator of claim 1 wherein the first optical filter is disposed on a first surface of a first optical substrate, and the second optical filter is disposed on a first surface of a second optical substrate.

5. The optical multi-filter discriminator of claim 1 wherein the first optical filter is disposed on a first surface of a first optical substrate, and the second optical filter is disposed on a second surface of the first optical substrate.

6. The optical multi-filter discriminator of claim 1 wherein the first optical filter and the second optical filter each is a band pass filter.

7. The optical multi-filter discriminator of claim 1 wherein the first optical filter and the second optical filter each is a thin film Fabry-Perot filter.

8. The optical multi-filter discriminator of claim 1 wherein the first optical filter and the second optical filter are mounted together in a single, hermetically sealed housing.

9. The optical multi-filter discriminator of claim 8 wherein:
the input port comprises a first optical fiber in a first ferrule fitted to the housing, and
the output port comprises a second optical fiber in a second ferrule fitted to the housing.

10. The optical multi-filter discriminator of claim 8 wherein:
the input port comprises a first optical fiber in a first ferrule fitted to the housing, and
the output port comprises a second optical fiber in the first ferrule.

11. The optical multi-filter discriminator of claim 10 further comprising a third optical fiber in the first ferrule.

12. An optical communication system comprising:
an optical signal source operative to generate optical signals;
an optical multi-filter discriminator optically coupled to optical signal source, the optical multi-filter discriminator comprising:
a. a first optical filter transmissive of at least a first wavelength band having a first center wavelength and reflective of at least a second wavelength band different from the first wavelength band; and
b. a second optical filter optically coupled to the first optical filter; and
c. an input port operative to receive optical signals from an optical signal source and oriented to launch the optical signals directly or indirectly to the first optical filter; and
d. an output port oriented to receive optical signals treated by the first and second optical filters and operative to pass the optical signals directly or indirectly to an optical waveguide;
wherein the optical multi-filter discriminator defines an optical path for optical signals in the first wavelength band received by the input port, the optical path comprising:
from the input port directly or indirectly to and through the first optical filter, and
from the first optical filter directly or indirectly to the second optical filter prior to the output port, at an angle of incidence at which the second optical filter is reflective of the first wavelength band.

13. The optical communication system of claim 12 wherein the optical signal source comprises a directly modulated laser.

14. The optical communication system of claim 12 wherein the optical multi-filter discriminator is an optical dual filter discriminator wherein the first optical filter and the second optical filter are mounted together in a single, hermetically sealed housing.

15. The optical communication system of claim 15 wherein the optical signal source comprises a laser mounted in the single, hermetically sealed housing with the first optical filter and the second optical filter.

16. The optical communication system of claim 16 wherein the laser is a directly modulated laser.

17. The optical communication system of claim 15 wherein the second optical filter is transmissive of the second wavelength band and reflective of the first wavelength band and the optical path for optical signals in the first wavelength band further comprises transmission through the second optical filter to the output port.

18. The optical communication system of claim 15 wherein the second optical filter is reflective of the first wavelength band and transmissive of the second wavelength band, and the optical path for optical signals in the first wavelength band further comprises reflection from the second optical filter back to the first optical filter and then again through the first optical filter to the output port.

19. The optical communication system of claim 15 wherein the second optical filter is transmissive of the first wavelength band and reflective of the second wavelength band, and the optical path for optical signals in the first wavelength band further comprises transmission through the second optical filter to the output port.

20. The optical communication system of claim 12 wherein the first optical filter is disposed on a first surface of a first optical substrate, and the second optical filter is disposed on a first surface of a second optical substrate.

21. The optical communication system of claim 12 wherein the first optical filter is disposed on a first surface of a first optical substrate, and the second optical filter is disposed on a second surface of the first optical substrate.

22. A method of operating an optical communication system comprising:
generating optical signals by modulating input current to an optical signal source;
passing the optical signals to the input port of an optical multi-filter discriminator;
launching the optical signals from the input port directly or indirectly to a first optical filter of the optical multi-filter discriminator at an angle of incidence, the first optical filter being transmissive of at least a wavelength band having a first center wavelength within the optical signals and reflective of other wavelengths within the optical signals;
passing the optical signals through the first optical filter directly or indirectly to a second optical filter of the optical multi-filter discriminator at a second angle of incidence, the second optical filter being optically coupled to the first optical filter and being reflective of the first wavelength band at the second angle of incidence;
following processing, if any, by optional addition optical filters of the optical multi-filter discriminator, passing the optical signals directly or indirectly to a second optical waveguide via an output port of the optical multi-filter discriminator, and
carrying the optical signals received from the optical multi-filter discriminator to a receiver at least in part via the second optical waveguide.

23. The method of claim 22 wherein the first center wavelength and the second center wavelength are in the C-Band.

24. The method of claim 23 wherein the first center wavelength is from 16 pm to 200 pm from the second center frequency.

25. The method of claim 24 wherein the optical signal source comprises a DML.

26. The method of claim 25 wherein processing the optical signals through the optical multi-filter discriminator increases the extinction ratio from a value less than 5 to a value greater than 5.

27. The method of claim 22 further comprising the second optical filter reflecting the first wavelength band back to the first optical filter and then again passing the first wavelength band through the first optical filter to the output port.

28. The method of claim 22 further comprising the second optical filter passing the first wavelength band to the output port.
